(19) United States
(12) Patent Application Publication
(10) Pub. No.: US 2026/0214367 A1
(43) Pub. Date: Jul. 23, 2026

(54) RECHARGEABLE HEARING DEVICE

(71) Applicant: Oticon A/S, Smørum (DK)

(72) Inventors: Mikkel Finmand Kjær NIELSEN, Smørum (DK); Poul HENRIKSEN, Smørum (DK)

(21) Appl. No.: 19/414,365

(22) Filed: Dec. 10, 2025

(30) Foreign Application Priority Data
Jan. 17, 2025 (EP) 25152548.1

(51) Int. Cl. H04R 1/10

(52) U.S. Cl. CPC H04R 1/1025; H04R 1/1016

(57) ABSTRACT

Embodiments of the disclosure relates to methods, devices and systems for charging of hearing devices, specifically for charging hearing aids. The hearing device is configured to be inductively charged via a loop structure and includes a housing, at least one microphone, a processor, a rechargeable battery, and a receiver. The hearing device advantageously includes a loop structure arranged at an outer surface part of the housing. The loop structure is configured to receive a wireless electronic signal from a charging device to charge the hearing device's comprising rechargeable battery.

### CROSS REFERENCE TO RELATED APPLICATIONS

Any and all applications for which a foreign or domestic priority claim is identified in the Application Data Sheet as filed with the present application are hereby incorporated by reference under 37 CFR 1.57.

### FIELD

The present disclosure relates to methods, devices and systems for charging of hearing devices, specifically for charging hearing aids.

### BACKGROUND

Custom-style hearing aids are designed and manufactured based on the unique shape of a user's ear canal. These devices are primarily configured for placement within the ear canal and come in a variety of styles, sizes, and component configurations to suit individual needs and preferences. They are lightweight and ergonomic, enhancing user comfort. For smaller custom-style devices, such as In-the-Ear (ITE) or Completely-in-Canal (CIC) models, a string is often attached to the outer face of the device to facilitate easy removal from the ear canal. However, because each device is customized for the individual user, fitting them into a standard charging device becomes problematic. Standardized charging solutions may result in inadequate contact between the hearing device and the charging device, leading to poor charging performance. There is a need for a universal charging solution that can accommodate custom-style hearing devices without the need to design and manufacture individualized charging units.

For Behind-the-Ear (BTE) hearing devices, it is important to facilitate charging for users with limited dexterity and sensory loss. To achieve this, the goal is to develop a charging interface that allows users to hang their hearing devices, rather than placing them on or in a charging platform.

For hearing devices in general, it is desirable to have a charging device that can be used with a variety of hearing devices. A standardized charging interface of the hearing devices could offer significant advantages as fewer variants of charging devices are required to be designed and produced.

Inductive coupling transfers energy between two coils through electromagnetic induction. When an alternating current flows through the primary coil, it creates a changing magnetic field. The magnetic field induces a voltage in the nearby secondary coil. The efficiency of this energy transfer depends on factors like the number of coil turns, their proximity, their alignment, and the presence of a magnetic core. Inductive coupling is used in transformers and wireless chargers.

### SUMMARY

In an aspect of the present disclosure, a hearing device configured to be inductively charged is disclosed. The hearing device may comprise a housing. The housing may comprise a rechargeable battery. The housing may comprise a processor. The hearing device may comprise at least one microphone. The at least one microphone can be arranged at an outer surface of the housing. The at least one microphone being configured to convert sound signals from the surrounding environment into electrical signals. The microphone is configured to provide the electrical signals representing the environmental sounds to the processor. Said processor may be configured to process the electrical signals provided by the microphone into electrical output signals. The hearing device may comprise a receiver. The receiver may be arranged in the housing. The receiver may be in communication with an outer surface of the hearing device. The receiver may be configured to provide a stimulus perceived by the user as an acoustic signal based on the processed electric signal from the processor. The hearing device may comprise a loop structure. The loop structure may be arranged at the outer surface of the housing. The loop structure may be configured to receive a wireless charge signal to charge the hearing device's comprising rechargeable battery. The loop structure may be configured to allow the hearing device user to remove the hearing device from their ear by pulling the loop structure. The rechargeable battery is configured to be charged via the loop structure.

Advantageously, arranging the loop structure on the outer surface of the housing places it closer to a transmitter of the wireless charging signal, thereby enhancing the reliability of charging the hearing device. Moreover, advantageously, the loop structure can be implemented on hearing devices irrespective of the form or shape of the housing, thereby allowing the same loop structure to be used without modification regardless of customized design changes of individual hearing devices.

As an additional advantage, arranging the loop structure on the outer surface of the housing enables the hearing device to be compatible with different charging interfaces. For example, the hearing device may be charged by hanging the loop structure on a hook-type charging interface, placing it on a charging pad, or inserting it into a cavity-type charging interface. This configuration facilitates easier charging of the hearing device for users with limited dexterity or reduced finger sensation by simplifying the process of users to find a charging interface matching their needs. Further, arranging the loop structure on the outer surface of the housing advantageously allows the charging interface of the hearing device to be located outside the housing, thereby providing more space within the housing for arranging critical components in an efficient arrangement, as the charging interface does not, or only to a low degree, occupy internal housing space.

The present disclosure may be combined with a variety of different types of hearing devices and charging setups. The present disclosure relates to both behind-the-ear devices and devices that are placed in the ear canal. The present disclosure further relates to both custom-style and non-custom-style hearing aids.

In an aspect, the present disclosure relates to a system for charging a hearing device. The system may have at least two parts that could be connected via inductive coupling and/or physical attachments. One part may be a hearing device comprising a secondary coil, and one part may be a charging device comprising a primary coil. The charging device may be connected to an external power grid via a standard electrical outlet, or it could also be equipped with an internal battery that is recharged using external power. When the charging device is connected to the hearing device via inductive coupling, the primary coil generates an electromagnetic field, which is used to wirelessly transfer energy to the secondary coil in the hearing device. An idea of this disclosure is about establishing an inductive coupling between a primary coil in a charger device and a secondary coil in a hearing device with the purpose of charging a rechargeable battery in the hearing device. The inductive coupling between the primary coil and secondary coil is required for energy transfer. Without an inductive coupling, inductive charging of the hearing device is not possible. The secondary coil can be arranged in a loop structure. The loop structure may be made of a magnetically conductive material.

The system can include any and/or all advantages of the hearing device.

The hearing device is configured to be inductively charged. In other words, the hearing device is configured to be non-contact charge (e.g., charged without contact). The hearing device is configured to be charged wirelessly. For example, the hearing device is configured to be charged wirelessly from a transmitter. The hearing device is configured to receive wireless charging.

The hearing device can be a hearing aid.

The hearing device can include a housing. The housing can define an outer surface of the hearing device. The housing can include one or more electronic components of the hearing device. The housing can have an outer surface. The outer surface can face away from the hearing device. The housing can have an inner surface. The inner surface can define an inside of the hearing device.

The housing can have an outermost surface. The outermost surface can define an outer surface of the housing. One or more components can be attached to the outermost surface of the hearing device.

The housing can contain, for example, a rechargeable battery. The rechargeable battery can be configured to receive inductive charging.

The housing can contain a processor. The processor can be configured to process the electrical signals provided by the microphone into electrical output signals.

The housing can include further electronic components as well, and the components are not limiting.

The hearing device can include at least one microphone (e.g., input unit). The at least one microphone can be configured to receive sound signals from the surrounding environment.

The at least one microphone may be configured to convert sound signals from the surrounding environment into electrical signals and further provide the electrical signals representing the environmental sounds to the processor. The at least one microphone can be arranged at (e.g., on) the outer surface of the housing. The at least one microphone can be arranged at (e.g., on) the outermost surface of the housing.

The hearing device can comprise a receiver (e.g., output unit). The receiver can be in communication with an outer surface of the hearing device. The receiver may be configured to provide a stimulus perceived by the user as an acoustic signal based on the processed electric signal from the processor.

The hearing device can include a loop structure (e.g., loop, wireless power loop). The loop structure can be arranged at the outer surface of the housing. The loop structure can be arranged at an outermost surface of the housing. For example, the loop structure can be external to the housing. A user can access the loop structure without having to open the housing. The loop structure extends away from the housing. The loop structure may not extend internal to the housing. The loop structure can be attached to the housing. The loop structure can be attached to an outermost surface of the housing.

The loop structure is configured to allow the hearing device user to remove the hearing device from their ear by pulling the loop structure. The loop structure is configured to allow the hearing device user to remove the hearing device from their ear by applying a force to the loop structure.

The loop structure can be configured to receive a wireless charge signal to charge the hearing device's comprising rechargeable battery. The loop structure can be in electrical and/or wireless connection with the rechargeable battery. For example, the loop structure can include wired connection to the rechargeable battery.

The rechargeable battery is configured to be charged via the loop structure. The loop structure can include wires, conductors, etc. to receive wireless power.

The loop structure can be configured to receive wireless charging. The loop structure can be in communication with the rechargeable battery to provide the wireless charging to the rechargeable battery. The loop structure can be a secondary coil. The loop structure can be a secondary coil for establishing an inductive coupling, for example with a wireless charger. Advantageously, in some examples the loop structure can both be configured to receive wireless power and be pulled on by a user.

The loop structure may comprise a ball head feature, bulbous feature, rounded tip or other geometric shaped feature. The ball head feature, rounded tip or other geometric shaped feature may be configured to enhance the user's grip of the loop structure when removing the hearing device from the ear canal. The loop structure may comprise a gripping element.

The loop may be formed from a string. The thickness of the string forming the loop structure may vary in different sections of the loop structure. The loop structure may provide enhanced fixation or retention in the ear canal. The loop structure may facilitate extraction of the hearing device from the ear canal. The loop structure may make the device easier to handle for people with limited dexterity and sensory loss of sensation in fingers compared to using a traditional string design.

When the hearing device is used the loop structure may be arranged in the pinna of the user during use. When the hearing device is used the loop structure may be arranged behind the pinna of the user during use. When the hearing device is used the loop structure may be arranged in the ear canal of the user during use.

The loop structure may be a string. The loop structure may be a loop feature. The loop structure may be a protruding feature. The string or loop feature, or the protruding feature may comprise a secondary coil for establishing an inductive coupling with a primary coil in a charger. The hearing device may include a component protruding from the hearing device, configured to receive a wireless charge signal for charging the hearing device's rechargeable battery. The loop structure may be fixedly attached to the housing of the hearing device or detachable therefrom.

Arranging a coil for charging in a loop configuration can advantageously result in the coil generating a stronger and more focused magnetic field compared to a non-loop arrangement. This is because the magnetic field lines are better confined within the loop, thereby enhancing the efficiency of wireless energy transfer between the loop structure and a charging coil in a charger.

The loop structure may protrude from the housing of the hearing device. The loop structure may be attached to the housing in at least one attachment point. The loop structure may be attached to the housing at one attachment point. The loop structure may be attached to the housing at two attachment points.

The loop structure may comprise a string with both ends connected to the hearing device's housing, wherein the string forms a loop.

The loop structure may comprise a string connected to the housing in at least one point, wherein the string may split into at least two strands, which diverge and reunite to form a loop.

The loop structure may be foldable (e.g., bendable, flexible), wherein the loop structure is folded (placed in or in close distance to the hearing device's housing) during use of the hearing device and unfolded (increased distance between loop structure and housing) when the loop structure is being used to charge the hearing device. The loop structure could be configured with a hinged structure which makes the loop structure fold in and out like a battery door. The foldable loop structure can be more discrete and space efficient when the hearing device is not charging compared to when it is charging. The foldable loop structure can be configured and arranged on different types of hearing devices, such as BTE and ITE hearing devices. In certain embodiments, a configuration of the loop structure may be a loop structure wound around the hearing device's housing or another part of the hearing device.

The loop structure may be arranged at an outermost surface of the hearing device's housing. The loop structure can be external to the housing.

The loop structure can be attached to the housing's outermost surface. The loop structure can be attached to the housing's outermost surface with a single attachment point. The loop structure can be attached to the housing's outermost surface with several attachment points. The loop structure can be wound around the housing's outermost surface. Advantageously, configuring the loop structure to charge the hearing device's rechargeable battery at the outermost surface of the device's housing may enhance the inductive connection with a charger, as the loop structure is positioned closer to the charging interface.

In one or more examples, a majority of the loop structure may be arranged outside (e.g., external to) the outermost surface of the hearing device. For example, over 50% of the loop structure may be arranged outside the outermost surface. For example, over 90% of the loop structure may be arranged outside the outermost surface. For example, over 95% of the loop structure may be arranged outside the outermost surface.

Advantageously, positioning the loop structure outside the housing of the hearing device makes it easier for a user to grip the loop structure. If the user can easily grip the loop structure, the user can more easily use the loop structure to pull the hearing device out of the ear canal by pulling the loop structure. If the user can easily grip the loop structure, the user can more easily ensure that the loop structure is correctly connected to the charging interface by allowing the user to visually see and feel the charging interface of the hearing device. Arranging most of the loop structure outside the outermost surface of the hearing device helps minimize the effect of the charger's magnetic field on the internal components of the device's housing. By directing the majority of inductive energy transfer toward the loop structure itself, potential interference with the hearing device's internal components is reduced.

In certain examples, the housing may further comprise, but is not limited to, a shell and a faceplate. The shell and the faceplate may be combined to enclose a volume. The shell and faceplate may be an in-ear hearing device. The shell may be configured to be arranged in the ear canal of the user when the hearing device is used. The faceplate may be arranged in the ear canal of the user.

In certain examples, the housing may further comprise a casing. The casing may be configured for a BTE hearing device. The casing may be arranged behind the user's pinna when the hearing device is used.

In certain examples, the housing may further comprise an encapsulated casing. The encapsulated casing may be made of an encapsulation material. The encapsulation casing may be formed by introducing an encapsulation material into a mold configured to define the shape of the housing. The mold may accommodate one or more hearing device components, including but not limited to the receiver, the microphone, and the rechargeable battery. The encapsulation material may comprise an epoxy-based compound.

The housing of a hearing device may comprise, but is not limited to, the shell and the faceplate, or a 3D-printed housing assembled from two or more parts, or a casing for a BTE hearing device, or an encapsulated casing.

The loop structure may have at least one contact point with the outermost surface of the faceplate of the hearing device's housing.

The loop structure may comprise a secondary coil. The secondary coil may be configured to form an inductive coupling with a charger's primary coil. The inductive coupling may form when the loop structure is arranged on the charger device. The inductive coupling may wirelessly charge the hearing device's rechargeable battery. The loop structure may include a wire.

The loop structure may comprise several windings of conductive material. The several windings may be encased in a jacket. The jacket can comprise a polymer-based material. The several windings of conductive material may be the secondary coil.

In certain examples, the loop structure comprises several windings, e.g. 10-100 windings, of a conductive material. A higher number of windings gives more design freedom and makes transformer design less critical. The windings may be isolated from one another. The windings may be encased in a jacket comprising a polymer material.

The jacket can serve a number of purposes. For example, the jacket can prevent the windings from being sharply bent, maintain the shape of the loop structure, and improve the robustness of the loop structure.

The windings and the jacket together can form a string. The loop structure may comprise a string in a loop formation. A diameter of the string may be less than 1 mm when no forces are applied to the loop structure. A diameter of the string of 1-2 mm may be advantageous to reach sufficient robustness when the loop structure is configured for use as a user interface, e.g. if the loop structure is configured for removing the hearing device from the user's ear or for mechanically connecting it to an external device, such as a charging device. A diameter of 2-10 mm may be advantageous if the loop structure is configured to secure the hearing device in the user's ear.

The loop structure may comprise several smaller loops. The loop structure may comprise a system of interconnected loops that is configured to form a framework within the user's pinna.

The loop structure can be designed in various ways by adjusting the thickness of the strings building up the loop structure and incorporating different sizes of loops. This includes combinations of smaller and larger loops within a system of loops. The loop structure may combine loop features, string features, and other geometrically shaped features, forming a framework. The framework may be stiff to create support in the ear. Advantageously, the framework improves the stability of the hearing device in the user's ear during use. Further, the framework makes it easier for a user with limited dexterity or reduced finger sensation to insert the hearing device in the ear and to connect the loop structure to a charger.

A system could comprise a charging device and the hearing device as disclosed herein. The charging device may be configured to inductively charge the hearing device. The hearing device may be charged when the loop structure with a secondary coil is positioned within an inductive charging range of a primary coil of the charger device.

Further disclosed herein is a charging device. The charging device can be configured to charge the rechargeable battery. The charging device can be configured to charge the rechargeable battery via the loop structure.

The secondary coil and the primary coil could be positioned close to each other with physical contact. The secondary coil and the primary coil could be positioned close to each other without physical contact. As used herein, “close” can include being within an inductive charging range.

The charging device may be configured to partly (e.g., partially) enclose the loop structure.

The charging device may be configured to completely enclose the loop structure.

The charging device may be configured to enclose the loop structure via at least two charging arms. The at least two charging arms may comprise a first charging arm and a second charging arm.

The first charging arm may comprise a first coil. The second charging arm may comprise a second coil. The primary coil may comprise the first coil in the first charging arm and the second coil in the second charging arm. The first coil and second coil may be configured to be aligned when the charging device is charging the hearing device.

At least one of the two charging arms may be configured to be rotatable about a horizontal axis and/or a vertical axis.

The first charging arm or the second charging arm may be hinged in the attachment with the charging device. The first charging arm or the second charging arm may be turntable. Advantageously, turning the first or the second charging arm may create a distance between the charging arms. The distance between the first and second charging arms allows for the loop structure to be inserted between the charging arms. When the loop structure has been inserted between the charging arms, the first or second charging arm can be turned to its original position with the arms aligned and enclosing the loop structure.

The charging device may comprise a charging rod that, while charging, is enclosed by the loop structure.

The charging arms or the charging rod may comprise a primary coil.

The hearing device may comprise an output unit for providing a stimulus perceived by the user as an acoustic signal based on a processed electric signal. The output unit may comprise an output transducer. The output transducer may comprise a receiver (loudspeaker) for providing the stimulus as an acoustic signal to the user (e.g. in an acoustic (air conduction based) hearing device).

The hearing device may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound.

The hearing device may be constituted, by or form part of, a portable (i.e. configured to be wearable/worn) device comprising a local energy source, e.g. a battery, e.g. a rechargeable battery. The hearing device may be a low weight, easily wearable, device, e.g. having a total weight less than 100 g, such as less than 20 g, such as less than 5 g.

The hearing device may be configured to operate in different modes, e.g. a normal mode and one or more specific modes, the mode may be selectable by a user, or automatically set, such as based on detected current use or based on analysis of environmental conditions, such as sound scenes. A mode of operation may be optimized to a specific acoustic situation or environment, e.g. a communication mode, such as a telephone mode. A mode of operation may include a low-power mode, where functionality of the hearing device is reduced (to save power or during recharging), e.g. to disable wireless communication, and/or to disable specific features of the hearing device.

The hearing device may comprise several detectors or sensors configured to provide status signals relating to a current physical environment of the hearing device (e.g. the current acoustic environment), and/or to a current state of the user wearing the hearing device, and/or to a current state or mode of operation of the hearing device. Alternatively, or additionally, one or more detectors/sensors may form part of an external device in communication (e.g. wirelessly) with the hearing device. The detector/sensor may be one or more of: a temperature sensor, an accelerometer, a capacitive sensor, an EEG sensor, a PPG sensor. An external device may e.g. comprise another hearing device, a remote control, and audio delivery device, a telephone (e.g. a smartphone), an external sensor, etc.

The hearing device may comprise other relevant functionality for the application in question, such as sound processing including: compression, noise reduction, etc.

The hearing device may comprise a hearing instrument, e.g. a hearing instrument adapted for being located at the ear or fully or partially in the ear canal of a user.

As outlined in the background section, custom-style hearing devices do not have well-defined surface areas for recharging in a wireless or contact charging device due to their custom-style design. Therefore, it is desirable for custom-style hearing devices to be rechargeable independently of their custom-style design. Custom-style and non-custom in-ear hearing devices often comprising a string making the hearing device easier to extract from the ear canal. The loop structure (e.g., string) may be configured the same way for mostly custom-style and non-custom in-ear hearing devices, regardless of the device's design. The hearing device's component configured for extraction of the hearing device from the ear canal, such as a string or a loop structure may also be configured to receive an electrical signal to recharge the battery of the hearing device in the present disclosure. Advantageously, the loop structure could be a uniform charging interface for several types of hearing devices, such as custom in-ear, non-custom in-ear, BTEs, and encapsulated hearing devices. Having a uniform charging interface simplifies production of the hearing devices. The hearing device with the loop structure can further make the hearing device housing smaller since the charging interface may be comprised in the loop structure which is arranged outside the outermost surface of the housing. Therefore, making the housing smaller and possible to insert further into the ear canal of the user and increase the fit of the hearing device in the ear canal.

In an aspect the present disclosure provides, a hearing device configured to be inductively charged is disclosed. The hearing device may be an ITE hearing device. The hearing device could include a shell. The shell may be configured to be placed in the user's ear canal. The shell may be one of the parts that is custom style to the ear canal of the user. The faceplate may be configured to be attached to the shell. The shell and the faceplate may together form the housing of the ITE hearing device. The faceplate may form a user-interface of the hearing device. A hearing device as disclosed herein may advantageously comprise a microphone, a receiver, a loop structure, a battery, and a processor. The faceplate may be the surface to which the microphone and loop structure are being mounted. The loop structure could be configured to enable the user to extract the hearing device from the ear of the user. The loop structure may be configured to receive a wireless charge signal to charge the hearing device's rechargeable battery. The loop structure may comprise a coil for establishing an inductive coupling with a charging device. The microphone may be configured to gather audio signals from the surrounding environment and further provide the hearing device' processor with electrical signals representing the environmental sounds. The processor could be placed in the housing of the hearing device. The processor may process input signals into output signals. The receiver may be arranged at the outer surface of the hearing device and partly protruding the outer surface of the hearing device. The receiver may transform electrical signals from the hearing device's processor into audio signals. A rechargeable battery could be integrated into the housing of the hearing device. The rechargeable battery of the hearing device may be charged via the loop structure. The loop structure may be used both to extract the hearing device from the ear and to establish an inductive coupling with a charging device. While charging the hearing device, the loop structure can be coupled to the charging device in any way. The loop structure may be hung on the charger device. The loop structure may be put on a charging pad. Advantageously, the loop structure comprised in the hearing device may be placed in the charger device or be attached to the charging device.

Since the hearing device may be arranged in the user's ear canal, at least one loop structure may be attached to the hearing device to facilitate extraction of the hearing device from the ear canal. The loop structure may have at least one contact point with the outermost surface of the faceplate of the hearing device. The loop structure has at least one contact point with the outer surface of the housing of the hearing device. The loop structure may have one contact point comprising a single contact point. The at least one contact point may be a surface where the loop structure attaches to the hearing device's housing. Most of the loop structure may be arranged outside the outermost surface of the housing.

In the BTE hearing device may the loop structure be a receiver wire. One end of the receiver wire may be connected to the housing of the hearing device, which is placed behind the ear. The other end of the receiver wire may be connected to a receiver unit. The receiver unit may be configured to be placed in the user's ear canal. The receiver unit could be a speaker unit. The receiver wire may transmit electrical signals from the hearing device's housing, configured behind the user's ear, to the receiver unit configured in the user's ear canal.

The receiver wire may be formed as a loop during charging of the hearing device. The receiver wire may form a loop by a magnetic and electric interface between the receiver unit and the outer surface of the housing, wherein the receiver unit may attach to a magnetic and electric contact at the housing's outer surface. The receiver wire comprising a secondary coil may be inductively coupled with a primary coil in a charging device to recharge the hearing device's rechargeable battery. While charging the hearing device, the receiver wire may be hung on the charging device.

The BTE hearing device comprises a housing configured to be placed behind user's pinna. The receiver wire is arranged at the housing of the hearing device. One end of the receiver wire connects to the housing of the hearing device, while the other end is connected to a receiver unit equipped with a dome-like element, which may be customized to the user's ear canal. A BTE hearing device may advantageously comprise a microphone, a receiver, a receiver wire, a rechargeable battery, and a processor. The receiver wire may be configured to form a loop structure. The receiver wire end with a dome-like element may be possible to be attached to the housing of the hearing device, forming a loop structure. The dome-like element may be attached to the housing by a magnetic and electric connection. The receiver wire may comprise a secondary coil configured for establishing an inductive coupling with a charging device. The receiver wire may be configured to receive a wireless charge signal to charge the hearing device's rechargeable battery. The microphone may be configured to gather audio signals from the surrounding environment and further provide the hearing device's processor with electrical signals based on the environmental sounds. The processor could be placed in the housing of the hearing device. The processor may process input signals into output signals. The receiver may transform electrical signals from the hearing device's processor into audio signals. A rechargeable battery could be integrated into the housing of the hearing device. The rechargeable battery of the hearing device may be recharged via the receiver wire.

The hearing device can be configured to be partially positioned in the ear canal during use. To ensure proper function, it must fit accurately into the user's ear canal. The housing, shell, or dome-like element can be custom-style to the user's ear canal, providing a precise fit. Additionally, the housing, shell, or dome-like element may be 3D printed based on a digital scan of the user's ear canal.

The present disclosure could include a charging device. This charging device may be configured to charge the hearing devices described above. A primary coil may be configured in a charging interface, wherein the charging interface may be, but is not limited to, charging arms, a charging rod, or a charging cavity. The charging interface comprising a primary coil could be configured as a transmitter to wirelessly transfer energy to the hearing device. The charging device may be configured to inductively charge the hearing device when the loop structure is positioned close to a primary coil of the charger device, with or without having a physical contact. The charging device may induce an electrical current in the hearing device's secondary coil that charges the battery of the hearing device. The charging device and hearing device may thereby effectively form a transformer comprising a primary coil, a core and a secondary coil. The charging device may comprise a magnetically conductive material forming a primary coil. The hearing device's loop structure may comprise an electrically conductive material forming a secondary coil.

The charging device may comprise a main body and charging arms. The main body may comprise the power supply connection to the power grid. The charging arms are housing the primary coil, wherein the primary coil is configured to generate an electromagnetic field when an alternating current (AC) passes through it. The charging arms may be configured as a closed primary coil when the charging arms are combined in any point. The charging device may be configured to form an inductive couple to the hearing device by enclosing the loop structure or by encapsulating the loop structure with the charging arms. The charging device may enclose or encapsulate the loop structure configured with at least one charging arm. The charging device may enclose or encapsulate the loop structure configured with two charging arms. Encapsulating in this case means that the loop structure interlocks with the charging arms, alternatively the charging interface.

The charging arms can enclose or encapsulate the loop structure which ensures a proper placement of the loop structure in the charging device. The charging device may comprise a button, wherein pressing the button on the charging device may make the charging arms separate. The loop structure of the hearing device may be inserted between the charging arms of the charging device when the charging arms are separated. Releasing the pressure on the charging device's button may cause the charging arms to close, enclosing or encapsulating loop structure of the hearing device within the enclosed area formed by the closed charging arms. The charging device's charging arms may alternatively be opened and closed by using a hinge, magnetic, or slide solution. The opening mechanism can be done in any direction. The charging arms may be opened by rotating the charging arms around a horizontal axis and/or a vertical axis. The charging device's charging arms in closed position may form the primary coil. The charging device may include one or more loops of electrical wire around its charging arms to induce the magnetic flux in the primary coil. When the loop structure of the hearing device is enclosed or encapsulated by the charging arms, the hearing device and the charging device may be connected mechanically with each other.

The charging arms may be opened by rotating a first charging arm while keeping a second charging arm in a fixed position, wherein opening the charging arms may be forming a distance between the charging arms. Rotating the first charging arm may cause the first charging arm to separate from the second charging arm. When the first charging arm is separated from the second charging arm, the loop structure of the hearing device can be inserted between the charging arms. To align the first and second charging arms, the first charging arm is rotated so it aligns with the second charging arm. The first and second charging arms may align when the distance between them is less than the thickness of the loop structure.

The connection between the charging arms and the loop structure may have a loose fit. A loose fit allows for some movement between the charging arm of the charging device and the loop structure of the hearing device. The loose fit between the devices could allow for the hearing device to be charged in several different positions. The hearing device may be charged in a hanging position where the loop structure may be placed around the charging arm. The charging device may also be equipped with a support shelf next to the charging device. The hearing device may be charged via the loop structure while the housing rests on the support shelf.

Advantageously, the charging device may comprise a charging rod comprising a primary coil instead of charging arms. The rod may comprise a primary coil configured to generate an electromagnetic field when an alternating current (AC) passes through it, forming an inductive coupling to the secondary coil in the hearing device. The hearing device's loop structure comprising a secondary coil could be hung on the rod forming an inductive coupling. The charging device may comprise a charging rod that, while charging, is enclosed by the loop structure. The thickness of the rod may vary along its length, with the tip being thinner than the sections further away to facilitate easy docking of the hearing device's loop onto the charging device's rod. The rod can have any shape. The rod may be curved. The rod may be straight. The rod may have a uniform thickness along the whole length of the rod.

Advantageously, the charging device may be configured with a charging cavity, wherein the surface of the charging cavity is embedded in magnetically conductive wiring material, forming a primary coil. The embedded wiring may be arranged in circular patterns on the inner surface of the charging cavity. The secondary coil of the hearing device may be placed in the charging device's charging cavity and inductively couple the charging device with the hearing device.

The solution to charge the hearing device by inductive coupling between the charging device and the hearing device may result in a standardized charging solution. Since, the same loop structure may be mounted to many hearing devices, independently of the custom-style of the housing, the loop structure makes it possible to use a charging device standardized to the design of the loop structure rather than customized the charging device to the design of the hearing device. Using the loop structure to recharge the hearing device ensures that the interface between the loop coil in the hearing device and the loop coil in the charging device is sufficient to transfer power between the devices with electromagnetic induction. The solution may also facilitate the connection of hearing devices to charging devices for people with limited dexterity or sensory loss.

In the present context, a hearing device, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing device may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing device may comprise a single unit or several units communicating (e.g. acoustically, electrically or optically) with each other. The loudspeaker may be arranged in a housing together with other components of the hearing device or may be an external unit in itself (possibly in combination with a flexible guiding element, e.g. a dome-like element).

A hearing device may be adapted to a particular user's needs, e.g. a hearing impairment. A configurable signal processing circuit of the hearing device may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing device via an interface to a programming device (fitting system), and used by a processing algorithm executed by the configurable signal processing circuit of the hearing device.

A ‘hearing system’ refers to a system comprising one or two hearing devices, and a ‘binaural hearing system’ refers to a system comprising two hearing devices and being adapted to cooperatively provide audible signals to both of the user's ears. Hearing systems or binaural hearing systems may further comprise one or more ‘auxiliary devices’, which communicate with the hearing device(s) and affect and/or benefit from the function of the hearing device(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing devices, hearing systems or binaural hearing systems may e.g. be used for compensating for a hearing-impaired person's loss of hearing capability, augmenting or protecting a normal-hearing person's hearing capability and/or conveying electronic audio signals to a person. Hearing devices or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically illustrates blocks of a hearing device.

FIG. 2 schematically illustrates the system of the hearing device and the charging device.

FIG. 3A schematically illustrates an in-ear hearing device with a loop structure.

FIG. 3B schematically illustrates an in-ear hearing device with a loop structure.

FIG. 3C schematically illustrates an in-ear hearing device with a loop structure.

FIG. 3D schematically illustrates an in-ear hearing device with a loop structure.

FIG. 3E schematically illustrates an in-ear hearing device with a loop structure.

FIG. 3F schematically illustrates an in-ear hearing device with a loop structure.

FIG. 4A schematically illustrates a BTE hearing device with a receiver wire.

FIG. 4B schematically illustrates a BTE hearing device with a receiver wire formed as a loop.

FIG. 4C schematically illustrates a BTE hearing device with a loop structure wound around the housing.

FIG. 4D schematically illustrates a BTE hearing device with a foldable loop structure.

FIG. 5A schematically illustrates a system of a hearing device and a charging device.

FIG. 5B schematically illustrates a system of a hearing device and a charging device.

FIG. 5C schematically illustrates a charging device.

FIG. 5D schematically illustrates a system of a hearing device and a charging device.

FIG. 6A schematically illustrates the system of a hearing device and a charging device.

FIG. 6B schematically illustrates a system of a hearing device and a charging device.

FIG. 7A schematically illustrates the system of a hearing device and a charging device.

FIG. 7B schematically illustrates the system of a hearing device and a charging device.

FIG. 7C schematically illustrates the system of a hearing device and a charging device.

FIG. 8A schematically illustrates a cross-section view of the charging device while it is charging a hearing device.

FIG. 8B schematically illustrates a cross-section view of the charging device while it is charging a hearing device.

FIG. 8C schematically illustrates a charger device and a hearing device.

FIG. 8D schematically illustrates a cross-section view of the charging device while it is charging a hearing device.

FIG. 8E schematically illustrates a cross-section view of the charging device while it is charging a hearing device.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

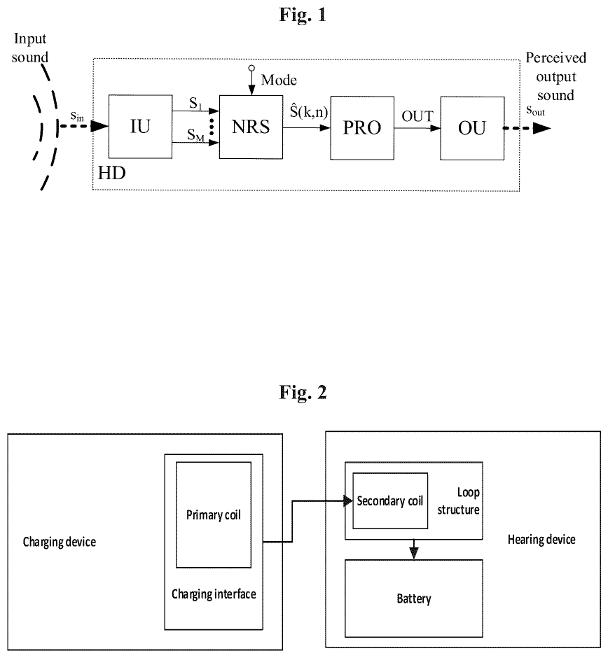

FIG. 1 shows an exemplary block diagram of a hearing device, e.g. a hearing device (HD), comprising a noise reduction system (NRS) and a hearing device (audio) processor (HAG) for compensating for a hearing impairment of a user of the hearing device. The hearing device comprises an input unit (IU) for picking up sound sin from the environment (e.g. by M input transducers, e.g. microphones) and providing a multitude (M, M>1) of electric input signals (S1, . . . , SM) and a noise reduction system (NRS) for estimating a target signal Ŝ in the input sound sin based on the electric input signals and optionally further information, e.g. a mode control signal (Mode). The mode select input (Mode) may be configured to indicate a mode of operation of the system, e.g. of beamformer(s) of the noise reduction system (NRS) and/or a filter coefficient updating strategy, e.g. depending on whether the target signal is the user's own voice or a target signal from the environment of the user (and possibly to indicate a direction to or location of such target sound source). The mode control signal may e.g. be provided from a user interface, e.g. from a remote control device (e.g. implemented as an APP of a smartphone or similar device, e.g. a smartwatch or the like). The mode control signal (Mode) may e.g. be automatically generated, e.g. using one or more sensors, e.g. initiated by the reception of a wireless signal, e.g. from a telephone. The output of the noise reduction system (NRS) may be an estimate of the user's voice ŜOV, or an estimate of a target sound from the environment ŜENV. The hearing device, e.g. a hearing device or headset, further comprises a (audio) processor (PRO) for applying one or more processing algorithms to a signal of the forward path from input to output, e.g. (as here) to the estimate Ŝ of the target signal, provided by the noise reduction system, e.g. in a time-frequency representation (Ŝ(k,n)). This may e.g. enabled by respective analysis filter banks (e.g. forming part of the input unit (IUMIC), possibly together with respective analogue to digital converters, as appropriate) providing each of the electric input signals (S1, . . . , SM) in a time frequency representation (k,n), k and n being frequency and time indices, respectively. The one or more processing algorithms may e.g. comprise a compression algorithm configured to amplify (or attenuate) a signal according to the needs of the user, e.g. to compensate for a hearing impairment of the user. Other processing algorithms may include frequency transposition, feedback control, etc. The processor (PRO) provides a processed output (OUT) that is fed to a synthesis filter bank (FBS) for conversion from the time-frequency representation (frequency domain) to the time domain. Time domain output signal (out) is fed to an output unit (OU) for conversion to stimuli sound perceivable by the user as sound (Output sound), e.g. acoustic vibrations (e.g. in air and/or skull bone) or electric stimuli of the cochlear nerve (in which (latter) case, the synthesis filter bank (FBS) may be omitted). In a non-hearing device, e.g. headset application, the processor may be configured to further enhance the signal from the noise reduction system or be dispensed with (so that the estimate Ŝ of the target signal is fed directly to the synthesis filter bank/output unit). The target signal may be the user's own voice, and/or a target sound in the environment of the user (e.g. a person (other than the user) speaking, e.g. communicating with the user).

FIG. 2 schematically illustrates a system, wherein a hearing device with a loop structure comprising a secondary coil is inductive coupled to a charging device having a charging interface comprising a primary coil. The charging interface may be charging arms, charging rod, or a charging cavity. The inductive coupling is configured to charge the battery comprised in the hearing device. The charging device draws energy from a pre-charged internal battery or an electrical power outlet (mains socket or the like).

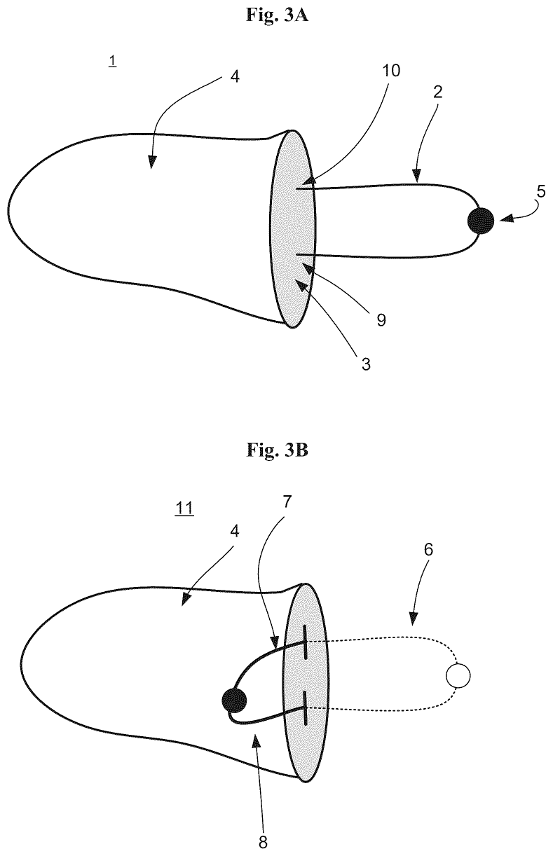

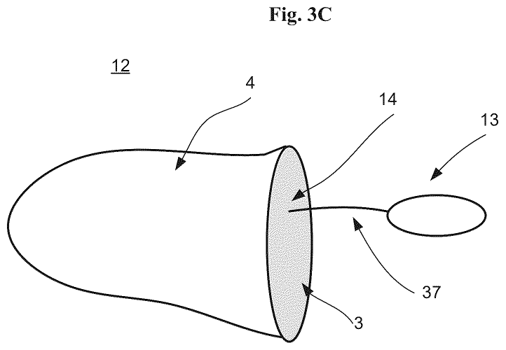

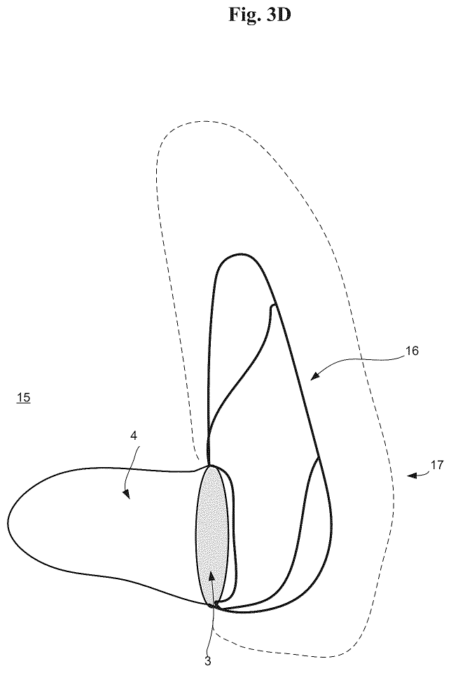

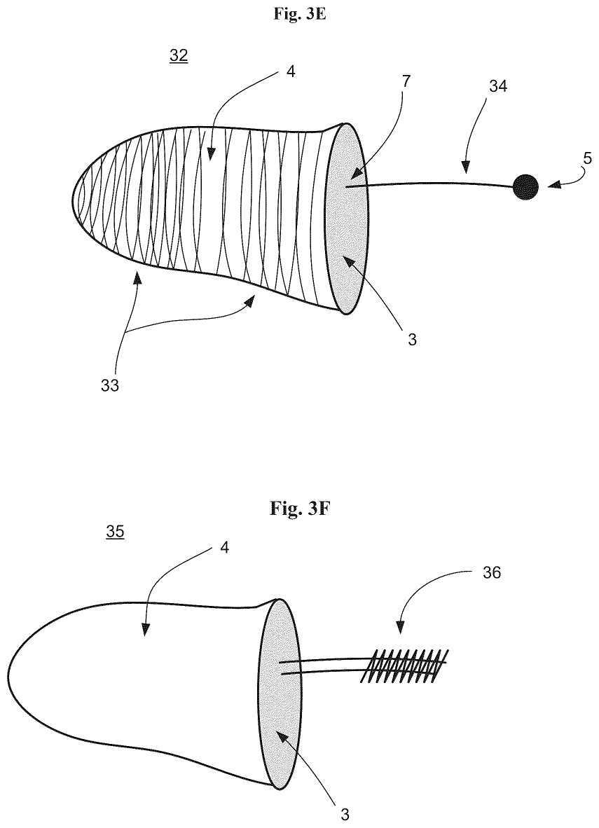

FIG. 3A schematically illustrates an in-ear hearing device (1) with a loop structure (2). The housing comprises a shell (4) and a faceplate (3). The shell (4) is the part of the hearing device that is configured to be placed in the user's ear canal. The shell (4) is ergonomically shaped to the user's ear canal. The shell (4) is designed and 3-D printed based on a digital scan of the user's ear canal. The loop structure is configured with a ball head feature (5). The loop structure (2) is flexible and bendable. The loop structure (2) is formed by a string that attaches to two attachment points (9, 10) at the faceplate (3). The faceplate (3) is facing out of the user's ear during use. Microphones, loop structure (2) and setting-adjustable equipment are attached to the faceplate (3). The loop structure allows for the user to use the loop structure to both remove the hearing device from the ear canal and hang the loop structure (2) on a charging device. The loop structure (2) comprises a secondary coil configured to be inductively coupled to the primary coil in a charging device. Since the loop coil is a part of the loop structure (2), the battery is charged via the loop structure (2). The loop structure (2) has two contact points with the faceplate (3) which further is attached to the shell (4) of the in-ear hearing device (1). The housing comprises and protects the hearing device's microphone, receiver, processor, and battery. The processor is processing input signals into output signals. The microphone is configured to gather sound signals from the surrounding environment and further provide the hearing device's processor with electrical signals representing the environmental sounds. The receiver is transforming electrical signals from the hearing device's processor into sound signals.

FIG. 3B schematically illustrates an in-ear hearing device (11) featuring a foldable loop structure 1.0 (8). The distinction between the hearing device illustrated in FIG. 3B and the one depicted in FIG. 3A is the foldable loop structure 1.0 (8). The solid line (7) shows the foldable loop structure 1.0 (8) in a folded position (during operation) and the dotted line (6) shows the foldable loop structure 1.0 (8) in an unfolded position (position during charging). The change between the unfolded and the folded position of the loop structure is made manually by turning the loop structure from unfolded to folded. Alternatively, the folding process may also be done similarly to how an accordion is compressed. The size of the foldable loop structure (8) may be larger or smaller depending on the hearing device type.

FIG. 3C schematically illustrates an in-ear hearing device (12) featuring a loop structure 2.0 (13). This loop structure is the primary distinction between the hearing device illustrated in FIG. 3C and the one depicted in FIG. 3A. The loop structure 2.0 (13) in this hearing device is made by a string that attaches to one attachment point (14) at the faceplate (3). The string (37) splits into two separate strands, which diverge and subsequently reunite to form the loop structure. The faceplate (3) is facing out of the user's ear and allows the user to use the loop structure to remove the hearing device from the ear canal and hang the loop structure 2.0 (13) on a charging device. The loop structure 2.0 (13) comprises a secondary coil configured to be inductively coupled to the primary coil in a charging device.

FIG. 3D schematically illustrates an in-ear hearing device (15) featuring a loop structure 3.0 (16). This loop structure is the primary distinction between the hearing device illustrated in FIG. 3D and those depicted in FIG. 3A and FIG. 3C. The loop structure 3.0 (16) comprises a system of interconnected loops that form a framework within the user's pinna (17). This design enhances the stability and fit of the device, ensuring it remains securely positioned during use. The system of loop structures attaches to the faceplate (3). The faceplate is facing out of the user's ear and allows for the user to use the loop structure to remove the hearing device from the ear canal and hang the loop structure 3.0 on a charging device. The loop structure 3.0 (16) comprises a secondary coil configured to inductive couple with a primary coil in a charging device.

FIG. 3E schematically illustrates an in-ear hearing device (32) featuring a loop structure 4.0 (33). In this hearing device, the loop structure 4.0 (33) is configured as a loop wound around the housing (4) of the hearing device. The loop structure may be positioned in any part of the indicated lines representing the loop structure, partly or in full. The loop structure 4.0 (33) comprises a secondary coil. The hearing device (32) is configured with a pull-out string (34) to enable the hearing device's user to extract the hearing device out of the ear canal.

FIG. 3F schematically illustrates an in-ear hearing device (35) featuring a loop structure 5.0 (36). The loop structure 5.0 (36) is a wound coil. The loop structure 5.0 (36) is configured as a secondary coil.

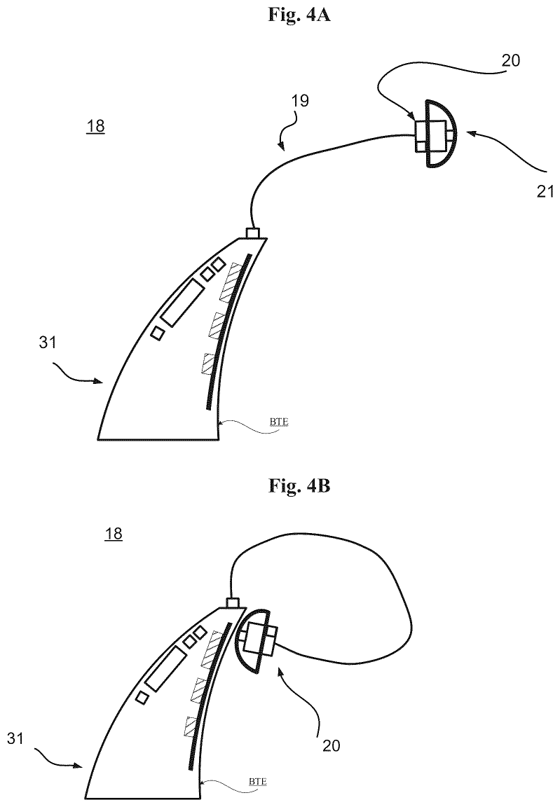

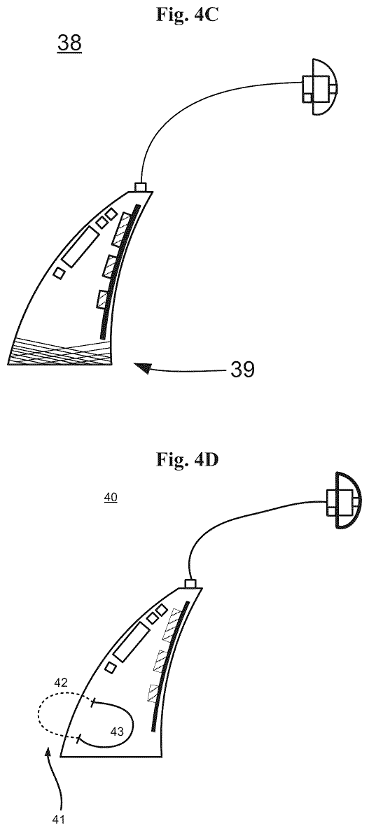

FIG. 4A schematically illustrates a BTE hearing device (18). The BTE hearing device comprises a housing (31), a loop structure configured as a receiver wire (19), a receiver (20), a dome-element (21) and a battery, wherein the dome-element is configured to be placed in the user's ear canal. The dome element is customized to the ear canal of the hearing device's user. The receiver wire is flexible and bendable. The receiver wire comprises a secondary coil configured to establish an inductive coupling with the primary coil in a charging device. The receiver wire (19) is a loop structure. The receiver wire (19) is configured to the housing (31) of the hearing device. The housing comprises microphone, battery, and processor. The housing is configured to be placed behind the user's pinna. One end of the receiver wire (19) connects to the housing (31) of the hearing device, while the other end is attached to a receiver unit (20) equipped with a dome-element (21).

FIG. 4B schematically illustrates the BTE hearing device (18) as the receiver wire is bent to a loop structure. The receiver unit (20) is connected to the housing's (31) surface with a magnetic and/or electric coupling. Once the loop structure is formed, a closed secondary coil is created in the hearing device's receiver wire.

FIG. 4C schematically illustrates the BTE hearing device (38). The loop structure (39) is configured as a coil wound around the housing of the hearing device. The loop structure (39) is configured as a secondary coil. The loop structure (39) size may vary.

FIG. 4D schematically illustrates a BTE hearing device (40) configured with a foldable loop structure (41). The dotted line (42) represents the unfolded loop structure, used during charging. The solid line (43) shows the loop structure in a folded position, which is recommended during use. The loop structure comprises a secondary coil. While charging the loop structure in hanged on charging arms, a rod, or placed in a cavity of the charging device.

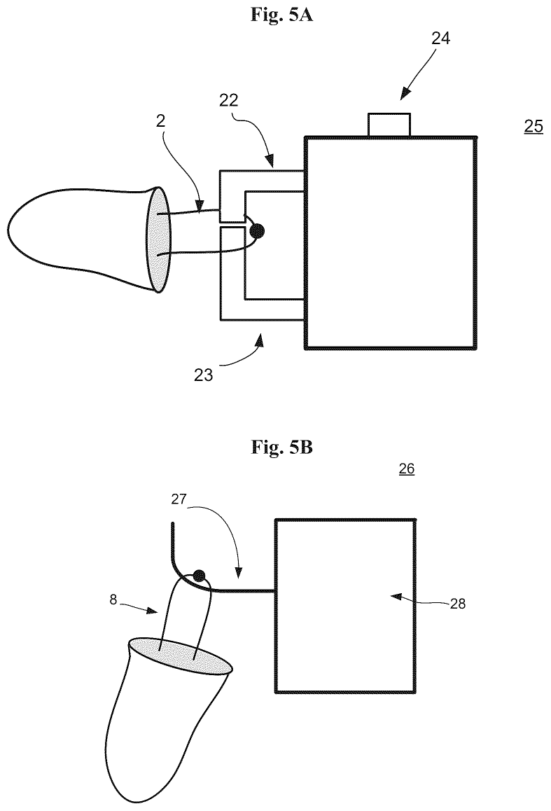

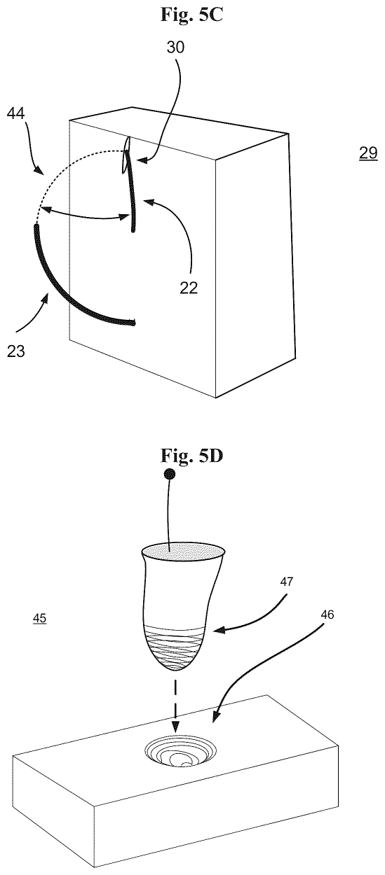

FIG. 5A illustrates the system of a hearing device (1) and a charging device (25), which utilizes two charging arms: the first charging arm (22) and the second charging arm (23). By pressing an opening button (24), the first charging arm (22) and the second charging arm (23) separate. When the charging arms separate, the secondary coil comprised in the loop structure of the hearing device (2) is either extracted or inserted between the two charging arms. Upon releasing the opening button (24), the gap between the first charging arm (22) and the second charging arm (23) closes. When the first charging arm (22) and second charging arm (23) are combined, the arms form a closed primary coil. When the secondary coil of the hearing device is enclosed by the charging arms, the hearing device is inductively coupled to the charging device. When the loop structure (2) is enclosed by the first charging arm (22) and the second charging arm (23), the hearing device and the charging device are mechanically connected with a loose fit. As a result of the loose fit connection, the hearing device can be charged in several different charging positions.

FIG. 5B illustrates the system of a hearing device (1) and a charging device (26), which utilizes a charging rod (27). The charging device comprises a main body (28) and a charging rod (27). The charging device is configured to charge hearing devices equipped with a loop structure (8). The rod comprises a primary coil configured to generate an electromagnetic field when an AC passes through it forming an inductive coupling to the secondary coil in the hearing device.

The rod is a curved shaped, but alternatively it may have another shape. The rod has a uniform thickness along its entire length, alternatively it may have varying thickness.

FIG. 5C illustrates a charging device (29). The charging device has charging arms that open and close by rotating the first charging arm (22) to the side, using a hinge solution (30). The dotted line (44) shows the first charging arm when the charging device is in a closed position. The first charging arm (22) made as a solid line shows the charging device when the device is in an open position. The second charging arm (23) is fixed, alternatively it may not be fixed. When the charging device is in an open position, a loop structure can be inserted or removed from the charging device. When the charging device is in a closed position, the charging arms form a closed primary coil. The method used to open the cavity enclosed by the charging arms is the primary distinction between the charging device shown in FIG. 5C and the one depicted in FIG. 5A.

FIG. 5D illustrates a charging device (45). The charging cavity (46) in the charging device (45) comprises a primary coil which is wound along the cavity's surface. During charging, the secondary coil of the hearing device is placed in the charging cavity (46). When a secondary coil (47) of a hearing device is placed in the charging cavity of the charging device, an inductive coupling is formed between the hearing device and charging device.

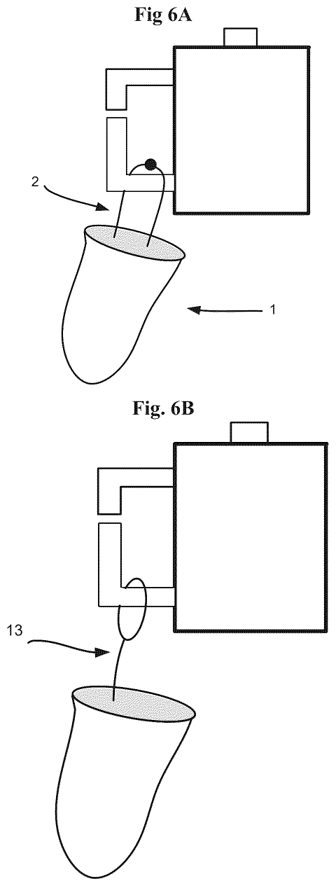

FIG. 6A shows the in-ear hearing device (1) with the loop structure (2) hanging in charging position at the charging device with charging arms.

FIG. 6B illustrates the in-ear hearing device with the loop structure 2.0 (13) hanging in the charging position at the charging device with charging arms.

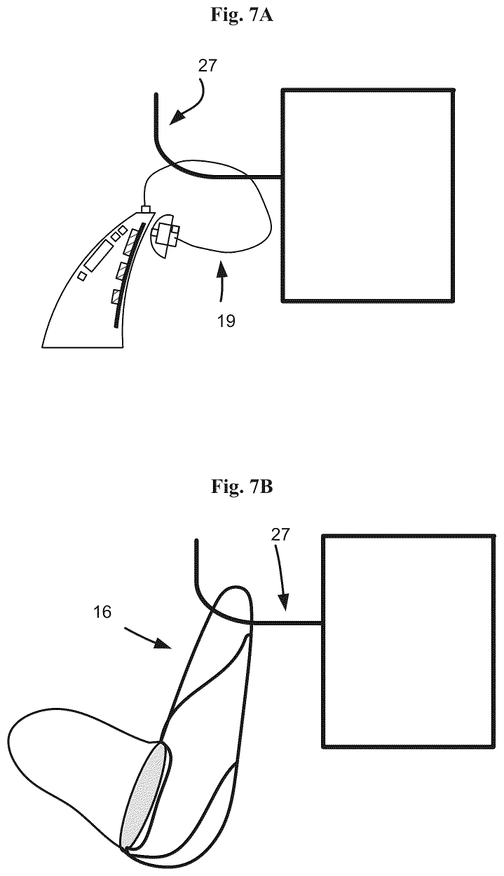

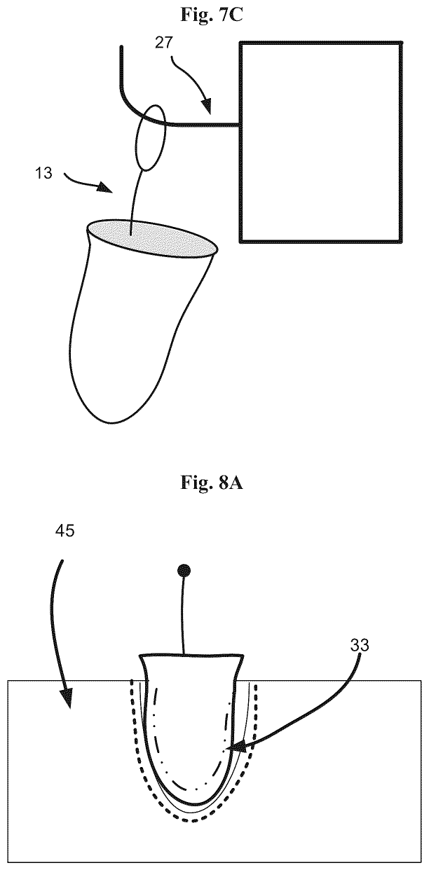

FIG. 7A shows a BTE hearing device with the receiver wire (19) formed into a loop structure by having a magnetic and electric coupling between the receiver unit (20) and the housing (31) of the hearing device. The loop structure is hung on the charging rod (27) of the charging device.

FIG. 7B shows the in-ear hearing device with the loop structure 3.0 (16) hanging in charging position at the charging rod (27) of the charging device.

FIG. 7C shows the in-ear hearing device with loop structure 2.0 (13) hanging in charging position at the charging rod (27) of the charging device.

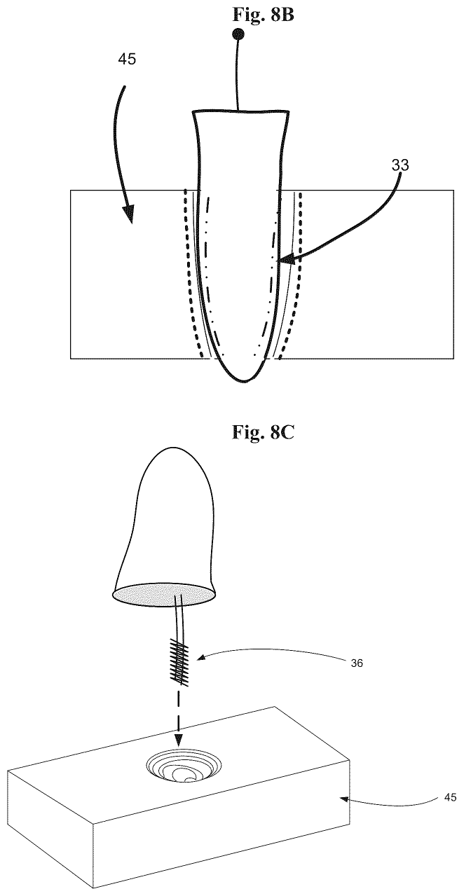

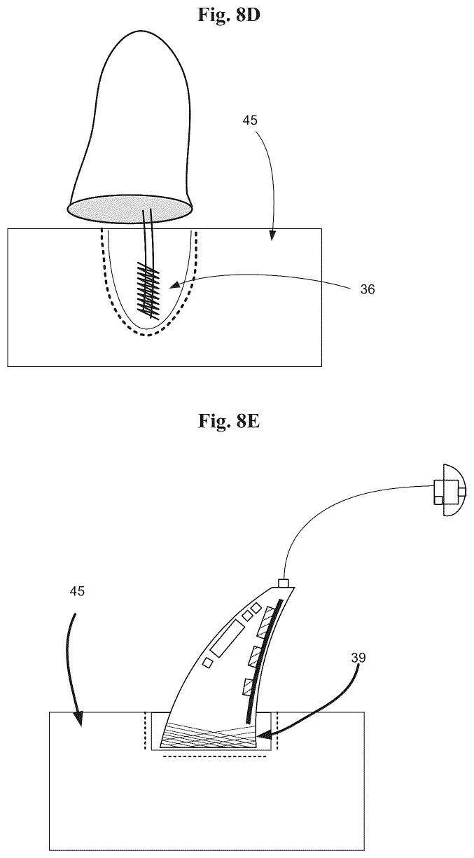

FIG. 8A illustrates a cross section of the charging device (45) with a charging cavity when the hearing device with a loop structure 4.0 (33) is placed in the charging cavity. The charging cavity does not extend through the whole thickness of the charging device. The primary and secondary loops may be positioned in any part of the indicated dotted lines, partly or in full.

FIG. 8B illustrates a cross section of the charging device (45) with a charging cavity, when the hearing device with a loop structure 4.0 (33) is placed in the charging cavity. The charging cavity extends through the whole thickness of the charging device. The primary and secondary loops may be positioned in any part of the indicated dotted lines, partly or in full.

FIG. 8C illustrates the charging device (45) with a charging cavity, when the hearing device with a loop structure (36) is placed in the charging cavity.

FIG. 8D illustrates a cross section of the charging device (45) with a charging cavity, when the hearing device with a loop structure (36) is placed in the charging cavity.

FIG. 8E illustrates a cross section of the charging device (45) with a charging cavity when the hearing device with a loop structure (39) is placed in the charging cavity.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A hearing device configured to be inductively charged, comprising:
a housing comprising a rechargeable battery and a processor;
at least one microphone arranged at an outer surface of the housing, the at least one microphone being configured to convert sound signals from the surrounding environment into electrical signals and further provide the electrical signals representing the environmental sounds to the processor;
said processor being configured to process the electrical signals provided by the microphone into electrical output signals;
a receiver in communication with an outer surface of the hearing device and configured to provide a stimulus perceived by the user as an acoustic signal based on the processed electric signal from the processor;
a loop structure arranged at the outer surface of the housing, wherein the loop structure is configured to receive a wireless charge signal to charge the hearing device's comprising rechargeable battery, wherein the loop structure is configured to allow the hearing device user to remove the hearing device from their ear by pulling the loop structure; and
wherein the rechargeable battery is configured to be charged via the loop structure.

2. The hearing device according to claim 1, wherein the loop structure is arranged at an outermost surface of the housing.

3. The hearing device according to claim 1, wherein the housing further comprises:
a shell and a faceplate combined to enclose a volume in an in-ear hearing device, wherein the shell is configured to be arranged in the ear canal of a user when the hearing device is used; or
a casing for a BTE hearing device that encloses a volume and is arranged behind the user's pinna when the hearing device is used; or
an encapsulation casing that is made of an encapsulation material.

4. The hearing device according to claim 3, wherein the loop structure has at least one contact point with the outermost surface of the faceplate of the hearing device's housing.

5. The hearing device according to claim 1, wherein the loop structure comprises a secondary coil configured to form an inductive coupling with a charger's primary coil.

6. The hearing device according to claim 1, wherein the loop structure comprises several windings of conducive material, wherein the several windings are encased in a jacket comprising a polymer-based material.

7. The hearing device according to claim 1, wherein the loop structure comprises a system of interconnected loops that is configured to form a framework within the user's pinna.

8. The hearing device according to claim 1, wherein a majority of the loop structure is arranged outside the outermost surface of the hearing device.

9. A system comprising:
a hearing device according to claim 1; and
a charging device, wherein the charging device is configured to inductively charge the hearing device when the loop structure with a secondary coil is positioned within an inductive charging range of a primary coil of the charger device.

10. The system according to claim 9, wherein the charging device is configured to partly enclose the loop structure.

11. The system according to claim 9, wherein the charging device is configured to completely enclose the loop structure.

12. The system according to claim 9, wherein the charging device comprises a charging rod that, while charging, is enclosed by the loop structure.

13. The system according to claim 9, wherein the charging device is configured to enclose the loop structure via at least two charging arms.

14. The system according to claim 13, wherein at least one of the two charging arms are configured to be rotatable about a horizontal axis and/or a vertical axis.

15. The system according to claim 13, wherein the at least two charging arms or the charging rod comprises a primary coil.
